(19) United States
(12) Patent Application Publication
(10) Pub. No.: US 2026/0346215 A1
(43) Pub. Date: Nov. 5, 2026

(54) METHOD AND APPARATUS FOR IN-LINE SMART FUEL BLENDING

(71) Applicant: HKA HYDROFUEL, LLC, Lafayette, LA (US)

(72) Inventors: Alexander R. Gomez, Houston, TX (US); Alvaro J. Cabrera, Cypress, TX (US)

(21) Appl. No.: 19/734,883

(22) Filed: Jul. 8, 2026

Related U.S. Application Data
(63) Continuation of application No. 18/781,516, filed on Jul. 23, 2024.
(60) Provisional application No. 63/515,146, filed on Jul. 24, 2023.

(51) Int. Cl. B01F 23/41; B01F 25/43; B01F 101/00

(52) U.S. Cl. CPC B01F 23/4145; B01F 25/43; B01F 2101/505

(57) ABSTRACT

A multi-fluid blending system employing low-energy static mixing provides efficient mechanical blending process for mass-producing thermodynamically stable hydro-fuels, eliminating the need of high-energy mixing equipment, and maintaining a compact, cost-effective design. Suitable for small to large-scale production, the system produces microemulsions following Hydrophilic-Lipophilic Difference (HLD) surfactant formulations. Modular design allows for scalable applications, from equipment installations to trailer-mounted units and onboard ships. The system ensures the production of hydro-fuel microemulsions using precise metering, dosing systems and low-energy static mixing. Hydro-fuels produced reduce engine combustion emissions and harmful pollutants, hydrocarbons, particulate matter, black carbon and smoke opacity, benefiting the environment and human health.

### CROSS REFERENCES TO RELATED APPLICATIONS

This application is a continuation of U.S. patent application Ser. No. 18/781,516 FILED Jul. 23, 2024, currently pending, which claims priority of U.S. Provisional Patent Application Ser. No. 63/515,146, filed Jul. 24, 2023, all incorporated by reference herein.

### STATEMENTS AS TO THE RIGHTS TO THE INVENTION MADE UNDER FEDERALLY SPONSORED RESEARCH AND DEVELOPMENT

None

### BACKGROUND OF THE INVENTION

### 1. Field of the Invention

The present invention pertains generally to fuels, and more specifically to fuel blending systems and methods. More particularly, the present invention pertains to production of hydro-fuel microemulsions using an in-line blending system. More particularly still, the present invention pertains to an automated system for affordable production of hydro-fuel microemulsions using low-energy method(s) not limited to static mixing tubes or pipes.

### 2. Description of Related Art

Various additives have been used to reduce mechanical noise associated with hydrocarbon fuels and enhance the combustion efficiency of said conventional fuels. Water-in-fuel emulsion fuels- or hydrosols-reveals changes in engine performance and exhaust characteristics when water is present during fuel combustion. However, emulsifying hydrocarbon fuel with water has certain well-recognized advantage including, without limitation, reduction of fossil fuel consumption, costs and emissions from diesel engines, turbine engines and boiler exhausts.

Conventional water-in-fuel emulsions are known scientifically as either macro-emulsions or nano-emulsions. Both are hydrosols yet have different characteristics such as droplet size and stability. Macro-emulsions generally comprise large fuel droplets with an outer layer of hydrocarbon fuel, middle surfactant layer, and inner water droplet. Said macro-emulsion fuel micelles are generally 700 nm to +1000 nm in diameter and are opaque in appearance. Larger size droplets are prone to instability effects caused by gravity and thermal effects outside of a relatively modest temperature range. Such droplet size also impacts operation of fuel filters, water/fuel separators, storage, transportation and fuel injection systems on combustion engines.

Compared to macro-emulsions, nano-emulsions form smaller sized droplets (typically in the lower nm size range), transmit light with a translucent to clear appearance, yet are not thermodynamically stable. Both macro-emulsions and nano-emulsions are based on the Hydrophilic-Lipophilic Balance (“HLB”) system, a measure used to describe the balance between the hydrophilic (water-attracting) and lipophilic (oil-attracting) parts of a surfactant. Nano-emulsions have droplets generally in the 10-100 nm size and have improved stability compared to macro-emulsions but are generally not capable of self-reassembly in the event of emulsion breakage. Due to their structure, nano-emulsions run the risk of coalescence and are prone to thermal instability which makes nano-emulsions difficult to use in real-world applications. Nano-emulsions are somewhat translucent to clear in appearance and generally require extensive and high energy emulsification processes in order to generate said nano-emulsions.

Microemulsions are based on the Hydrophilic-Lipophilic Difference (“HLD”) system. HLD is an emulsion system used to understand and predict the behavior of microemulsions, which are thermodynamically stable mixtures of water, oil and surfactant(s). Microemulsions can form spontaneously and are used in various applications due to their ability to emulsify oil and water phases effectively, requiring much less mechanical energy and relying largely upon chemical energy in associated surfactant(s). The HLD framework helps in determining the balance between the hydrophilic (water-attracting) and lipophilic (oil-attracting) properties of surfactants and how this balance affects the formation and characteristics of microemulsions.

Microemulsions are typically within the dimensional range of 1-100 nm, are thermodynamically stable, are capable of spontaneous self-reassembly, have the appearance of translucent to clear and remain thermally stable over a larger temperature range than macro-emulsions or nano-emulsions. Hydro-fuel microemulsions that are properly formulated with individual surfactants or surfactant package(s) can significantly enhance fuel operating conditions, as well as diesel engine or gas turbine performance. Moreover, with the application of advanced emulsification techniques of the HLD methodology, in certain embodiments said fuel microemulsions can maintain thermodynamic stability for extended periods at normal environmental conditions (such as, for example, conventional fuel storage, transfer and engine operation).

Fuel emulsions can be produced utilizing surfactants and water through a two-stage batch blending and intermediate mixing tank process. However, such conventional fuel emulsion production systems are limited in mass scalability under high flow conditions; such systems typically require intermediate mixing chambers with minimum required mixing periods.

Another conventional method of creating fuel emulsions requires the use of a low molecular weight additive(s) to facilitate low shear rate. However, such fuel emulsions still require shear via a kinetic mixing device via batch, semi-batch or continuous mixing process. Said mixing processes can include, without limitation, a pipeline static mixer or high pressure drop orifice plates. This method requires high energy mixing equipment and significant inherent chemical energy in order to create microemulsions.

Additionally, conventional methods of microemulsion production do not provide fuel compositions or microemulsion fuels that are capable of prolonged thermodynamic stability and/or increased fuel efficiency (work output enhancements) and/or specific fuel consumption while also significantly reducing the level of multiple emissions constituents generated upon combustion of the fuels including CO2, NOx, SO2, unburned hydrocarbons, N2O, particulate matter and/or black carbon.

A significant challenge with aqueous fuel emulsions or water-blended fuels is maintaining stability over time and during exposure to externalities such as extreme hot and cold temperatures that can be experienced in various settings where said fuels are consumed. It is well known that hydro-fuel emulsions can destabilize and separate or phase over time, particularly (macro) emulsions and nano-emulsions. The issues related to fuel emulsion separation/phasing are particularly severe in engines that are designed for specific fuel composition(s) in order to operate properly. When the emulsion separates/phases and alters the fuel's composition, engine components and performance can be significantly compromised. Thus, achieving long-term stability in fuel emulsions is crucial for commercial viability of said fuels.

Furthermore, conventional methods of aqueous fuel emulsion production require the use of high shear mixers such as Silverson design mixers with intense shearing rates and/or high energy ultra sonic equipment. In certain instances, a multistage arrangement is employed wherein both ultrasonics and high shear mixers are used in series to create a homogeneous emulsion with smaller droplet sizes. Such systems frequently utilize aging tanks to allow for intermediate mixing between blending stages. Nonetheless, such emulsions are still prone to the effects of gravity and other externalities such as extreme temperatures normally present in real market and engine operating conditions.

Ultrasonic systems are very expensive, require higher parasitic electrical loads and require significant routine maintenance. Ultrasonic systems are often arranged in series utilizing multiple (expensive) units. Such an arrangement becomes economically challenging to scale the blending of fuel to mass production, in turn, negatively impacting system economics.

Conventional systems also rely on high pressure emulsification systems that drive the fuels, water, surfactants and other additives across small porosity plates that magnify the shear rate, shredding the composition into small droplet sizes that enable the formation of smaller emulsified fuel droplets or micelles. However, such processes require significant pressure differentials and large pumps to create such fluid pressure differentials; pipes/vessels and other equipment with sufficient capacity to withstand such pressure loads are often expensive. High operating expenses, including electrical energy consumption, further makes large scale commercialization of hydro-fuel production economically unattractive.

One key benefit of emulsified fuels is their ability to reduce carbon intensity and overall greenhouse gas (GHG) footprint. However, the high electrical energy requirements of existing production methods-such as high shear mixing, homogenizers and ultrasonics-greatly increase the GHG footprint of said conventional production systems. Put another way, conventional production methods require substantial amounts of power (such as electricity), thereby increasing the carbon and GHG footprint of such production methods, which undermines the environmental benefits that emulsified fuels aim to achieve.

Thus, there remains a need for a type of emulsion that is thermodynamically stable, that enables quick and efficient reassembly in the event of breakage, reducing otherwise expensive fuel waste and/or equipment damage. The system for producing such hydro-fuel emulsion should address the issues of separation/phasing of aqueous fuel emulsions by offering a smart blending system and advanced chemistry that significantly enhances the stability of the hydro-fuel microemulsion, making it suitable for the real world market conditions. Further, said blending system should be more economical, have a smaller physical foot-print and be scalable. The production system should also be portable, while also being capable of being mounted on skid(s), vehicle(s) or mobile equipment, or onboard marine vessels or other movable equipment including, without limitation, trains, mining equipment, tractors, and the like.

### SUMMARY OF THE INVENTION

The present invention pertains to a method and apparatus for the production of hydro-fuels. More particularly, the present invention pertains to a method and apparatus for the in-line production of hydro-fuel microemulsions (a combination of fuel, surfactant, water, and/or other additives) using low-energy method(s) not limited to static mixing tubes or pipes, all of which that can be self-contained and/or integrated into new or existing infrastructure including, but not limited to, fuel hubs or terminals, refinery, job site or even onboard movable vessels or vehicles.

Unlike conventional hydro-fuel production systems, the method and apparatus of the present invention does not require the use of high shear mixers, ultrasonics, high pressure emulsification, hydrodynamic cavitation, homogenizers or other high energy mixing devices to form a hydro-fuel microemulsion. Further, unlike conventional systems, the present invention does not require high energy mixing devices/apparatuses to produce standard HLB formulation based macroemulsions or nano-emulsions. Surfactants can be added to the mixed fuels to prolong stability and prevent water-in-fuel emulsion bonds from breaking and separating/phasing over time.

The present invention comprises a method and apparatus for multi-fluid blending with at least one low-energy static mixing device designed for hydro-fuel production by laminar flow range. The primary objectives and advantages of the present invention include providing a superior mechanical fuel blending process capable of producing large volumes of hydro-fuel at scale. The system of the present invention eliminates the need for high-energy mixing, blending, and shearing equipment by utilizing a compact low-energy static mixing process. The system further features a small footprint and low capital cost, making it compact, cost-effective and capable of being rapidly deployed. Hydro-fuel produced in accordance with the present invention delivers improved engine performance, engine longevity, while significantly reducing GHG emissions and harmful pollutants.

The method and apparatus of the present invention allows for the production of microemulsions that follow Hydrophilic-Lipophilic Difference (HLD) surfactant formulations. A modular design allows for scalability in various applications, from equipment installations to portable trailer-mounted units, fuel terminal installations, and even onboard vessels or vehicles. The method and apparatus of the present invention can be used to produce in-line blended hydro-fuel microemulsions that are thermodynamically stable, ensuring long-term stability and effectiveness in real market conditions of the application. Additionally, the present invention eliminates the need for interstage storage and aging tanks, streamlining the blending process and enhancing overall production efficiency.

In a preferred embodiment, the present invention—sometimes referred to herein as an in-line Smart Blending System (SBS)—incorporates low-energy static mixing devices with precise metering and dosing instruments to produce hydro-fuel microemulsions including, in some embodiments, on a single pass through said system. Said invention further utilizes HLD formulated surfactant package(s) as a fluid medium metered and dosed in a staged mixing circuit to a base fuel. Said base fuel can comprise fuels and fuel oils including, but not limited to, kerosene, diesels, marine gas oils, light and heavy fuel oils, biofuels, renewable fuels and synthetic e-fuels.

Water can then be metered and dosed in a staged mixing circuit to said base-fuel and surfactant blend to produce a hydro-fuel, ideally in a single pass through the system. In a preferred embodiment, said system utilizes mixing devices having low mechanical energy requirements such as, for example, static mixers utilizing relatively low feed pump pressure and flow rate through said static mixers. Said static mixing devices can include, but are not limited to, conduits having helical, plated or baffled internal design. Heating devices can be beneficially included at least one stage circuit to ensure optimal blending temperatures and fluid viscosities of hydro-fuels.

In a preferred blending sequence, base fuel, surfactant and water are dosed and mixed independently in a blending process. Surfactant dosing in the blending process may consist of a package of various surfactants and other chemicals, or individual surfactants, independently dosed in the blending process. Additional additives may be dosed in the blending process by additional inlets and dosing system; said additives can including, without limitation, cetane improver, pour point depressants, biocides, nano particle powders or gases such as hydrogen.

In an alternative blending sequence, fuel can be pre-blended with individual surfactants, surfactant package and other additives, ready for the dosing and mixing of water to complete the production of the hydro-fuel microemulsion. Additional additives may be dosed in the blending process via additional circuit inlets and dosing systems; such additives can include, without limitation, cetane improver, pour point depressants, biocides, nano particle powders or gases such as hydrogen.

Hydro-fuel produced in accordance with the present invention enables significant reductions of GHG and harmful pollutants not limited to CO2, SO2, NOX, N2O, Hydrocarbons, Particulate Matter, Black Carbon, and Smoke Opacity. Reduction of said emissions has significant benefit to environment, human inhalation health, engine performance life and component wear and tear. The present invention also expands base fuel volume on an average not limited to 4:5 ratio (125%) and delivers meaningful fuel economy (also sometimes referred to as Specific Fuel Oil Consumption) on a net fuel basis.

The present invention can have multiple different embodiments and is fully scalable from small output systems to large-scall mass production systems. Said embodiments can include, but are not limited to, in-line SBS mounted on (sea) container(s), floating vessel(s), trailer(s) and/or on other portable equipment. The present invention beneficially lowers equipment cost requirements, while promoting lower energy consumption during production and lower corresponding emissions footprint.

### BRIEF DESCRIPTION OF THE DRAWINGS

The foregoing summary, as well as any detailed description of the preferred embodiments, is better understood when read in conjunction with the drawings and figures contained herein. For the purpose of illustrating the invention, the drawings and figures show certain preferred embodiments. It is understood, however, that the invention is not limited to the specific methods and devices disclosed in such drawings or figures.

Further, the drawings constitute a part of this specification and include exemplary embodiments of the membrane-based technology for extraction of value-added minerals from produced water. It is to be understood that in some instances, various aspects of the invention may be shown exaggerated or enlarged to facilitate an understanding of the invention. Therefore, the drawings may not be to scale.

FIGS. 1A and 1B depict perspective views of a hydro-fuel production system of the present invention for production and use of hydro-fuels in multiple different illustrative embodiments.

FIGS. 2A and 2B depict side schematic views of hydro-fuel production and use on a floating vessel (such as, for example, a cruise ship or ocean liner).

FIG. 3 depicts a first perspective view of a modular in-line smart blending apparatus of the present invention.

FIG. 4 depicts a front view of a modular in-line smart blending apparatus of the present invention.

FIG. 5 depicts a second perspective view of a modular in-line smart blending apparatus of the present invention.

FIG. 6 depicts a perspective and partial cut-away view of a first embodiment static mixer of the present invention.

FIG. 7 depicts a perspective and partial cut-away view of a second embodiment static mixer of the present invention.

FIG. 8 depicts a perspective view of an illustrative example of an in-line smart blending system of the present invention used to provide fuel to a conventional diesel engine.

FIG. 9 depicts an exemplary view of a comparison of appearance between a conventional base fuel and a hydro-fuel microemulsion produced by an in-line smart blending apparatus the present invention.

FIG. 10 depicts a perspective view of a mass flow fluid flow meter which can be utilized in an embodiment of in-line smart blending apparatus of the present invention.

FIG. 11A depicts a flowchart illustrating a multi-fluid blending process of the present invention utilizing a standard base fuel.

FIG. 11B depicts a flowchart illustrating a multi-fluid blending process of the present invention utilizing a premix base fuel.

FIG. 12A depicts a schematic view of a multi-fluid blending process of the present invention utilizing a conventional base fuel.

FIG. 12B depicts a schematic view of a multi-fluid blending process of the present invention utilizing a premix base fuel.

FIG. 13 depicts a detailed schematic view of an exemplary biofuel production assembly of the present invention.

FIG. 14 depicts a detailed schematic view of a base fuel circuit of said exemplary biofuel production assembly of the present invention depicted in FIG. 13.

FIG. 15 depicts a detailed schematic view of a surfactant circuit of said exemplary biofuel production assembly of the present invention depicted in FIG. 13.

FIG. 16 depicts a detailed schematic view of a water circuit of said exemplary biofuel production assembly of the present invention depicted in FIG. 13.

FIG. 17 depicts a detailed schematic view of a static mixing circuit of said exemplary biofuel production assembly of the present invention depicted in FIG. 13.

### DETAILED DESCRIPTION OF A PREFERRED EMBODIMENT

Before describing various embodiments of the present disclosure in further detail by way of exemplary description, examples, and results, it is to be understood that the apparatus and methods of the present disclosure are not limited in application to the details of specific embodiments and examples as set forth in the following description. The description provided herein is intended for purposes of illustration only and is not intended to be construed in a limiting sense. As such, the language used herein is intended to be given the broadest possible scope and meaning, and the embodiments and examples are meant to be exemplary, not exhaustive. Also, it is to be understood that the phraseology and terminology employed herein is for the purpose of description only and should not be regarded as limiting unless otherwise indicated as so. Moreover, in the following detailed description, numerous specific details are set forth in order to provide a more thorough understanding of the present disclosure.

It will be apparent to a person having ordinary skill in the art that the present disclosure may be practiced without these specific details. In other instances, features which are well known to persons of ordinary skill in the art have not been described in detail to avoid unnecessary complication of the description. It is intended that all alternatives, substitutions, modifications, and equivalents apparent to those having ordinary skill in the art are included within the scope of the present disclosure. Thus, while the apparatus and methods of the present disclosure have been described in terms of particular embodiments, it will be apparent to those of skill in the art that variations may be applied to the apparatus and methods and the steps or in the sequence of steps of the methods described herein without departing from the concept, spirit, and scope of the inventive concepts.

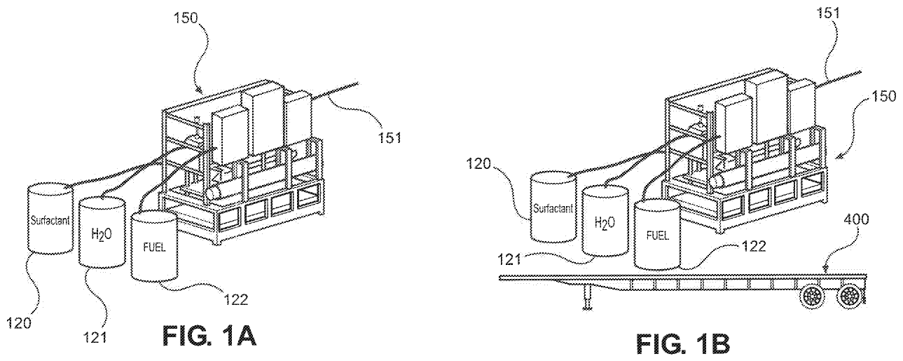

FIGS. 1A and 1B depict perspective views of a modular hydro-fuel production apparatus 150 of the present invention shown in different illustrative embodiments. FIG. 1A depicts a perspective view of skid-mounted in-line fuel blending apparatus 150 of the present invention. Said in-line fuel blending apparatus 150 is used to produce hydro-fuel microemulsions comprising a combination of fuel, surfactant, water, and/or other additives; said hydro-fuel microemulsions are discharged from in-line fuel blending apparatus 150 via output conduit 151. As depicted in FIGS. 1A, storage tanks 120, 121 and 122 having desired volume(s) can be used to store and provide said fuel, surfactant and/or water to said in-line fuel blending apparatus 150. Said skid-mounted in-line fuel blending apparatus 150 is relatively compact with a small footprint that can be quickly and efficiently installed and operated in a desired location.

FIG. 1B depicts a perspective view of said skid-mounted in-line fuel blending apparatus 150 that can be mounted on a conventional trailer 400. By mounting said in-line fuel blending apparatus 150 on conventional trailer 400, said in-line fuel blending apparatus 150 is fully portable; said trailer 400 with in-line fuel blending apparatus 150 can be quickly transported between multiple different locations in order to produce hydro-fuel in said different locations. Storage tanks 120, 121 and/or 122 can be mounted on said trailer 400 or situated at a fixed location that can be easily and conveniently accessed by trailer 400 and in-line fuel blending apparatus 150 situated thereon. Hydro-fuel microemulsions are discharged from in-line fuel blending apparatus 150 via output conduit 151. It is to be understood that said examples are illustrative only and should not be construed as disclosing all possible applications.

Additionally, said in-line fuel blending apparatus 150 can be added or integrated directly into equipment that is powered by liquid fuels. By way of illustration, but not limitation, said equipment can include, without limitation, electrical generators, trucks, tractors, automobiles, boats, vessels, pump system, power plants and any number of other applications. Hydro-fuel can be produced by said in-line fuel blending apparatus 150 in real-time in order to meet the fuel demand of said equipment including while said equipment is running and in operation. Further, hydro-fuel production and usage can be applied in open loop or closed loop fuel systems, and/or other types of fuel systems.

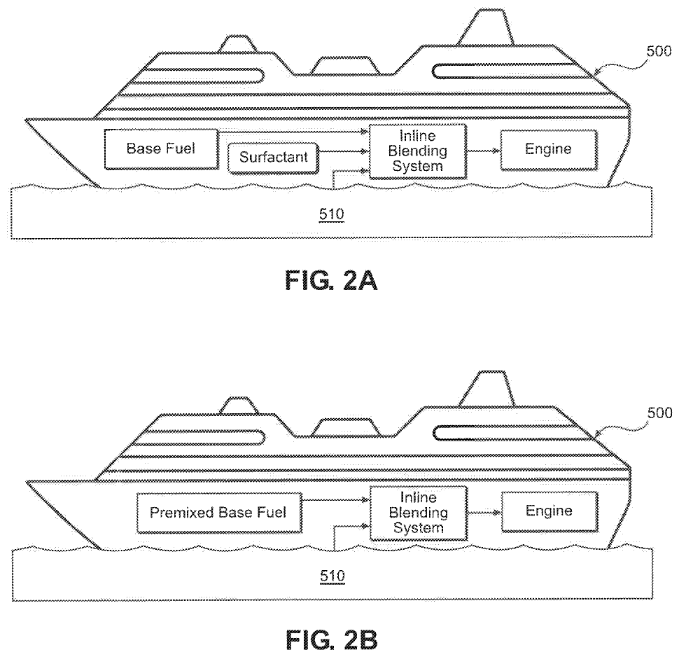

FIG. 2A depicts a side schematic view of hydro-fuel production and use on a floating vessel 500 (such as, for example, a cruise ship or ocean liner) disposed on body of water 510. As depicted in FIG. 2A, base fuel and surfactant can be stored in tanks or other storage facilities on vessel 500 and selectively supplied to an in-line fuel blending apparatus. Water can be supplied from body of water 510; such water supply can comprise water that vessel 500 already filters or otherwise treats for onboard usage, or which is generated by desalination reverse osmosis or other onboard water treatment method. In this application, hydro-fuel microemulsions can be produced by said in-line fuel blending apparatus in real-time in order to meet the fuel demand of vessel 500, including while said vessel 500 is running and in operation.

FIG. 2B depicts a similar side schematic view as shown in FIG. 2A; however in the embodiment depicted in FIG. 2B, the base fuel comprises a pre-mix containing predetermined proportions of at least one surfactant or surfactant package. Additional additives may be added to the blend and dosed in the hydro-fuel emulsion production process. Said additives can include, without limitation, cetane improver, pour point depressants, biocides or nano particle powders. In the embodiment depicted in FIG. 2B, the need for onboard surfactant storage is eliminated, thereby providing additional onboard space capacity for production and storage of hydro-fuel. Thus, the alternative embodiment depicted in FIG. 2B can provide a more efficient solution for onboard vessel application which can increase the relative range of vessel 500 illustrated in FIG. 2B.

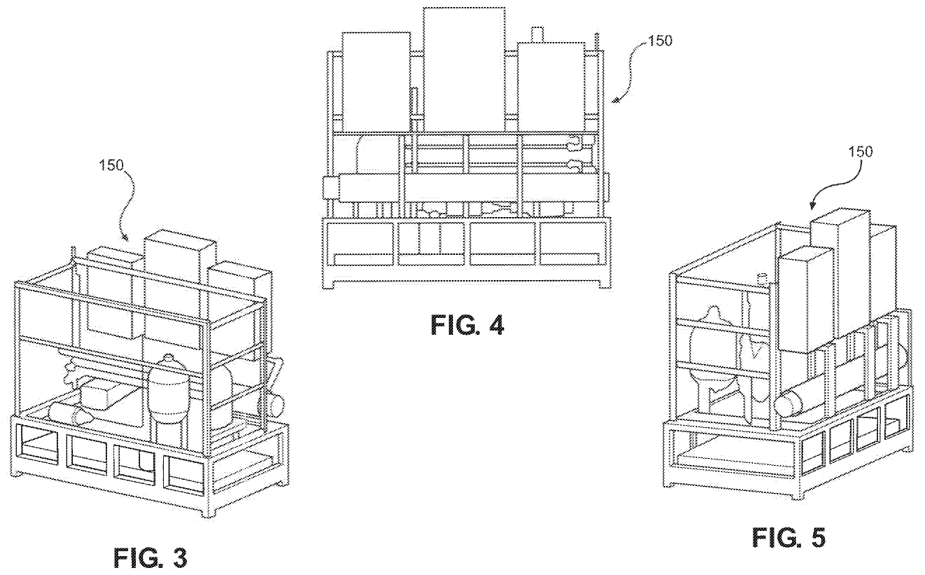

FIG. 3 depicts a first perspective view of a modular in-line smart blending apparatus 150 of the present invention. FIG. 4 depicts a front view of a modular in-line smart blending apparatus 150 of the present invention. FIG. 5 depicts a second perspective view of a modular in-line smart blending apparatus 150 of the present invention. Said modular in-line smart blending apparatus 150 can be used to produce hydro-fuel microemulsions and with a chemical formulation that enables low energy static mixing. Said hydro-fuel microemulsions generated by said in-line smart blending apparatus 150 comprise a thermodynamically stable solution ready to use in many conventional applications including, without limitation, diesel engines, turbine engines or boilers.

Referring to FIGS. 3 through 5, in-line smart blending apparatus 150 of the present invention generally comprises a plurality of integrated subsystems including, but not limited to, at least one heating element, at least one static mixer, at least one pump, at least one fluid meter, at least one dosing pump, at least one quality control and communication member and associated conduits or piping to connect said components. Said components cooperate in order to achieve low energy emulsification process described more fully herein. In a preferred embodiment, said in-line smart blending apparatus 10 is structurally supported and protected by a metal framework comprising structural tubes or members; provided, however, that the structural frame and apparatus/device support depicted in FIG. 3 through 5 illustrative only and can be easily customized to suit an intended application (including without limitation, use environment, space/weight constraints and the like.

Said in-line smart blending apparatus 150 of the present invention is fully scalable, and can be designed for small or large applications without affecting hydro-fuel microemulsion quality. Subsystems can be constructed from various materials not limited to black iron, carbon steel, stainless steel, PVC or other materials depending on the desired application. In-line smart blending apparatus 150 of the present invention is configured to produce self-assembled hydro-fuel microemulsion as fluids are blended using static mixer(s). At least one programmable logic controller (PLC) and human machine interface (HMI) can be used to control the operation of the said in-line smart blending apparatus 105 and quality of hydro-fuel produced. Quality control measures may be integrated to ensure quality of the inlets of base fuel, water, surfactant or pre-mix fuel, as well as outlet(s) of hydro-fuel.

Some embodiments of the present invention (and, particularly said PLC and/or HMI) may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer processor. Said processor may be a microprocessor, central processing unit (CPU), or other types of circuitry, while the memory may include volatile memory, non-volatile memory, and/or other types of memory. Said memory may store code (e.g., instructions, logic and/or commands) executed by a processor in the control of in-line smart blending apparatus 150 For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

In-line smart blending apparatus 150 uses a base fuel to produce a hydro-fuel; said base fuel can include, without limitation, diesel, gasoline, heavy fuel oil, marine fuels, kerosene, jet fuel, biodiesel, renewable diesel, synthetic e-fuel, or other liquid fuels. The conversion from base fuel to hydro-fuel in said in-line smart blending apparatus 150 comprises the following subsystems:
base fuel (or pre-mix fuel)
surfactant package (or no surfactant dosing/mixing required when pre-mix fuel is used)
water (purified water preferred, such as ultra filtration and reverse osmosis quality or better)

Said subsystems control the dosing accuracy of each component through volumetric and/or mass flow measurements, ensuring precise blend ratios. At this stage, all blend ingredients are mixed at an automated and controlled rate to produce the desired hydro-fuel at the outlet of said in-line smart blending apparatus 150. If the base fuel is already provided as a pre-mix fuel solution, an initial stage static mixer and surfactant(s) dosing would be unnecessary.

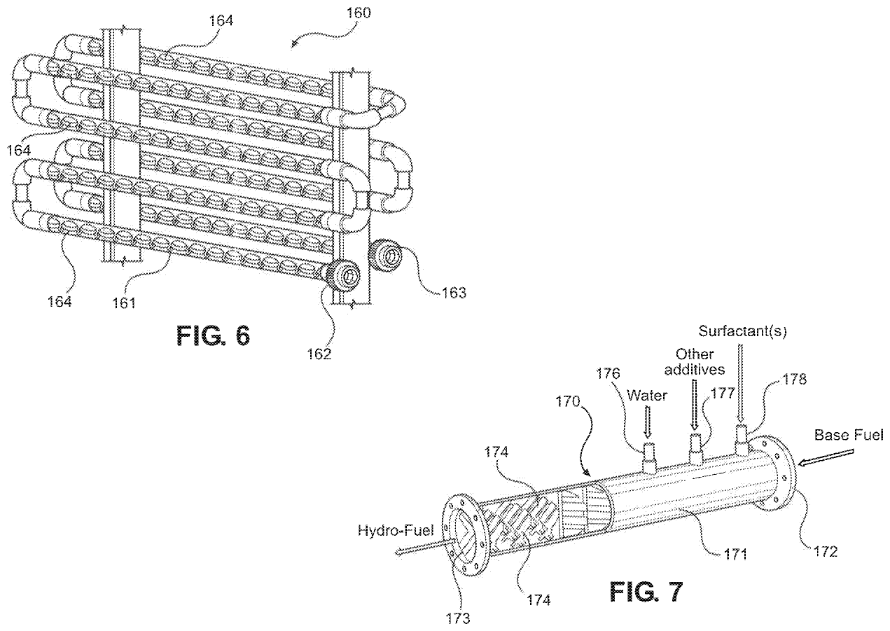

FIG. 6 depicts a perspective and partial cut-away view of a first embodiment static mixer 160 of the present invention. FIG. 7 depicts a perspective and partial cut-away view of a second embodiment static mixer 170 of the present invention. Said static mixers 160 and 170 comprise static mixing devices used to blend base fuel with surfactant(s); this base fuel/surfactant(s) mixture is then blended with water to form a homogeneous and highly stable hydro-fuel solution. It is to be understood that static mixer embodiments 160 and 170 are illustrative examples only; thus, the static mixing devices can be of various sizes, shapes, internal designs.

In a preferred embodiment, at least one static mixer of the present invention comprises a structural tube or other conduit having a plurality of in-line sections that provide desired turbulence and mixing of a plurality of fluids into a homogenous solution at its outlet. Dimensions of at least one static mixer can be dependent on the particular flow rates and temperatures of the application demand and can be arranged in a linear, cylindrical, serpentine, or other configuration. Static mixer(s) for use in the present invention are readily available from, but are not limited to, mixers marketed by Charles Ross & Son Company (and published at https://www.staticmixers.com/docs/staticmixer_designs.pdf), the entire contents of which are hereby incorporated by reference.

FIG. 6 depicts a perspective and partial cut-away view of a first embodiment static mixer 160 of the present invention. In the embodiment depicted in FIG. 6 said static mixer 160 comprises conduit body 161, fluid inlet 162 and fluid outlet 163. A plurality of internal mixing elements 164 are disposed in spaced arrangement within said conduit body 161; in a preferred embodiment, said mixing elements 164 can simultaneously produce patterns of fluid flow division and radial mixing. In the embodiment depicted in FIG. 6, conduit body 161 comprises a serpentine shape in order to promote desired fluid retention time and exposure to internal mixing elements 164 within static mixer 160.

FIG. 7 depicts a perspective and partial cut-away view of a second embodiment static mixer 170 of the present invention. In the embodiment depicted in FIG. 7, said static mixer 170 comprises conduit body 171, fluid inlet 172 and fluid outlet 173. A plurality of internal mixing elements 174 are disposed in spaced arrangement within said conduit body 171. Inlets 176, 177 and 178 extend into conduit body 171 and permit desired dosing of water, additives and/or surfactant(s) into said conduit body 171. It is to be observed that base fuel can flow into conduit body 171 via fluid inlet 172, while desired volume(s) of water, additives and/or surfactant(s) can be added to said base fluid within conduit body 171 via inlets 176, 177 and/or 178. As said components flow through conduit body 171, said components are exposed to internal mixing elements 174 and are precisely blended into hydro-fuel microemulsion flowing from fluid outlet 173.

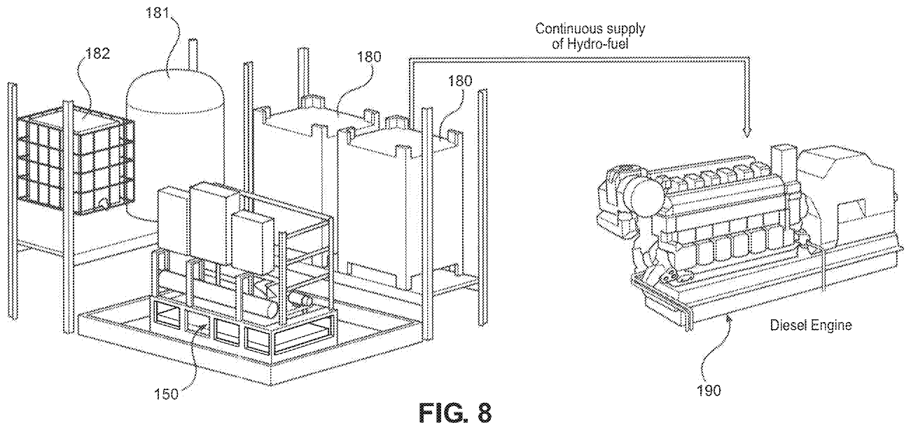

FIG. 8 depicts a perspective view of in-line smart blending apparatus 150 of the present invention. For continuous production of hydro-fuel using said in-line smart blending apparatus 150 as stationary or on-board equipment blending, the following components can be incorporated and utilized: external fuel tank(s) 180 for supplying base fuel, a water source (preferably purified) tank 181 and a surfactant package tank 182. In a preferred embodiment, a designated reservoir for water, base fuel and surfactant(s) package are beneficially provided. Hydro-fuel produced from in-line smart blending apparatus 150 can be transferred directly into a fuel storage tank of engine 190, or directly into a fuel system of said engine 190, depending upon operational preferences. Additionally, produced hydro-fuel can also be stored in tanks or other storage container(s) for later use.

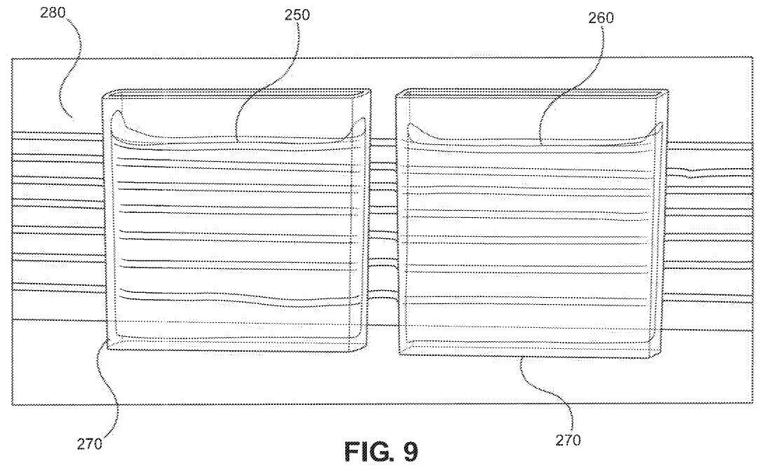

FIG. 9 depicts an exemplary view of a comparison of appearance of a base fuel 250 and a hydro-fuel microemulsion 260 produced in accordance the present invention (both depicted in transparent containers 270) against lined backdrop 280. Said base fuel fluid 250 can comprises at least one of various types of fuel sources including but not limited to kerosene, diesel fuels, heavy marine fuel oil, renewable diesel or synthetic e-fuels described further herein. Hydro-fuel produced in accordance with the present invention results in a clear microemulsion 260. Thus, FIG. 9 depicts a comparison between appearance of said base fuel 250 and finished hydro-fuel microemulsion product 260.

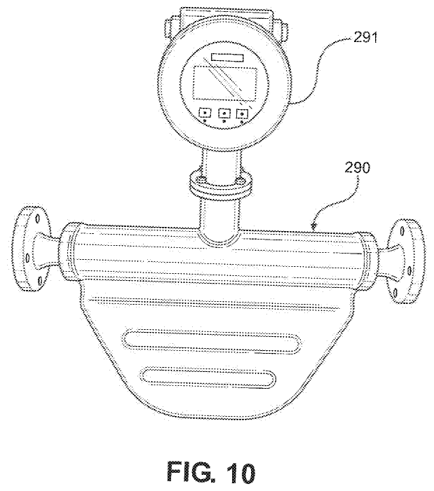

FIG. 10 depicts a perspective view of a mass flow fluid flow meter 290. Said mass fluid flow meter 290 can include readout display 291 and can include its own PLC. In a preferred embodiment of the present invention, multiple dosing and metering devices (such as, for example, mass fluid flow meter 290) can be used to precisely dose and measure the quantity and mixing of fluids or additive materials by volume or by mass.

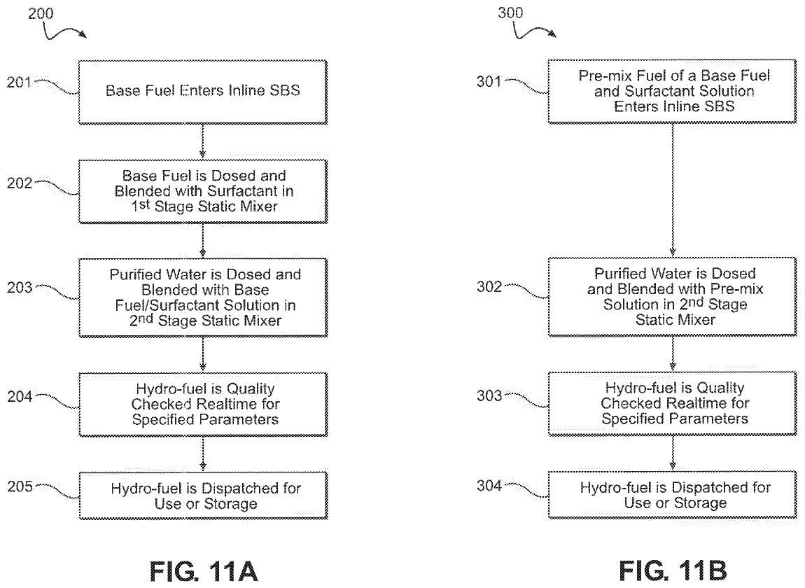

FIG. 11A depicts a flowchart illustrating a multi-fluid blending process 200 of the present invention utilizing a standard base fuel, while FIG. 11B depicts a flowchart illustrating an alternative multi-fluid blending process 300 of the present invention utilizing a premix base fuel. Referring to FIG. 11A, according to process 200, base fuel enters into an in-line smart blending apparatus at step 201 and is blended with a precises quantity of surfactant and mixed in a first stage static mixing apparatus at step 202. A homogeneous solution of base fuel and surfactant is then precisely dosed with a desired volume of metered water and then mixed in the second stage static mixer at step 203. A hydro-fuel microemulsion is then produced and monitored in real time at step 204 using an in-line fuel sampling device to measure numerous predetermined variables. At step 205, hydro-fuel effluent flows to an engine for use or alternative storage for later use in the application.

Referring to FIG. 11B, according to alternative process 300, a premixed homogeneous solution of base fuel and surfactant is pre-made; said premixed solution can be produced using conventional blending processes well known to those having skill in the art. Said premix fuel solution enters the In-line smart blending system at step 301. A desired volume of water is dosed and added to said premixed solution and directed to a static mixing apparatus at step 302. A hydro-fuel microemulsion is then produced and monitored in real time using an in-line fuel sampling device to measure numerous predetermined variables at step 303. Hydro-fuel effluent flows to an engine for use or alternative storage for later use in the application at step 304.

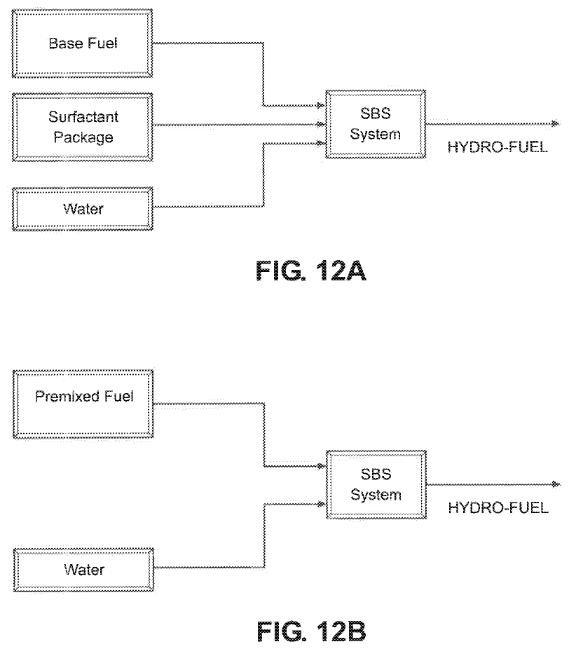

FIG. 12A depicts a preferred blending sequence, wherein base fuel, surfactant and water are dosed independently in the blending process. Surfactant dosing in the blending process may comprise a package of various surfactants and other chemicals, or individual surfactants, independently dosed in the blending process. Additional additives may be dosed in the blending process by additional inlets and dosing systems, not limited to cetane improver, pour point depressants, biocides, nano particle powders or gases such as hydrogen.

The multi-fluid blending process of the present invention depicted in FIG. 12A utilizes a conventional base fuel that can include, without limitation, diesel, gasoline, heavy fuel oil, marine fuels, kerosene, jet fuel, biodiesel, renewable diesel, synthetic e-fuel, or other liquid fuels. The conversion from base fuel to hydro-fuel in said in-line smart blending apparatus 10 comprises the following basic subsystems:
base fuel
surfactant(s)
water (purified water generally preferred, such as via ultra filtration and reverse osmosis quality or better)

FIG. 12B depicts an alternative blending process wherein pre-blended fuel (including, without limitation, individual surfactants, surfactant package and other additives) is prepared in advance and is ready for the dosing of water to complete the formation of the hydro-fuel microemulsion. Additional additives may be dosed in the blending process by additional inlets and dosing systems, not limited to cetane improver, pour point depressants, biocides, nano particle powders or gases such as hydrogen.

According to said alternative blending sequence, conversion from base fuel to hydro-fuel comprises the following subsystems:
pre-mix fuel (fuel and surfactant)
water (purified water generally preferred, such as ultra filtration and reverse osmosis quality or better).

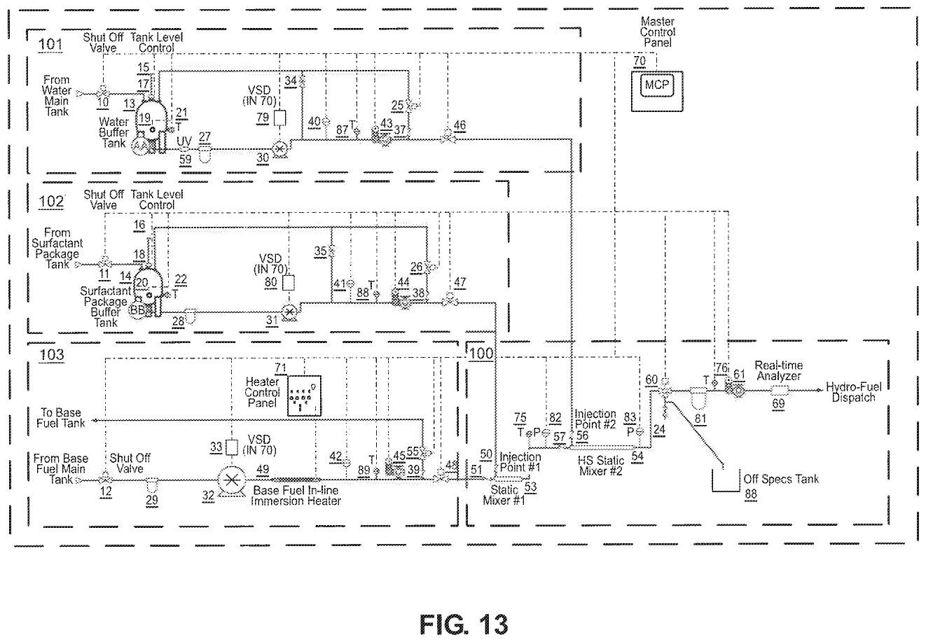

FIG. 13 depicts a detailed schematic view of an exemplary biofuel production system of the present invention including water circuit 101, surfactant circuit 102, fuel circuit 103, and static mixing circuit 100 of the microemulsion process with necessary instrumentation and communication controls. Precise dosing occurs through synchronized, measured and controlled process equipment that is connected and regulated by a master control panel and integral algorithms to ensure specified quality and quantity of hydro-fuel production. Blending sequence shown is a preferred method, but other sequences may be archived.

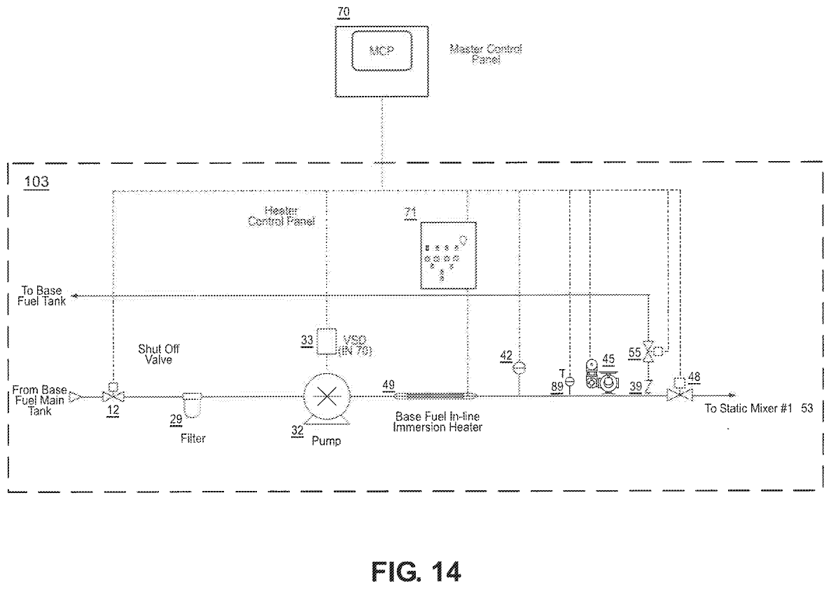

FIG. 14 depicts a detailed schematic view of a base fuel circuit of said exemplary biofuel production assembly of the present invention depicted in FIG. 13. Base fuel circuit 103 comprises base fuel source inlet, necessary valves, micro filter, pump with variable frequency drive and controller, fluid heater, temperature and pressure sensors, and precise metering and dosing equipment to supply specified base fuel or premix fuel temperature and quantity to static mixer(s) circuit inlet.

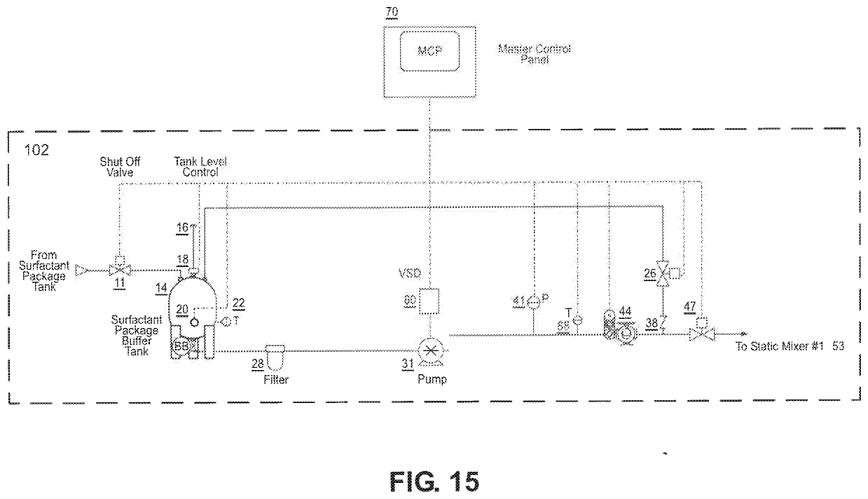

FIG. 15 depicts a detailed schematic view of a surfactant circuit of said exemplary biofuel production assembly of the present invention depicted in FIG. 13. Said surfactant circuit 102 includes inlet of surfactant package into circuit 102, including necessary valves, buffer reservoir tank, heater, micro filter, pump with variable frequency drive and controller, temperature and pressure sensors, and precise metering and dosing equipment to supply specified surfactant (if no premix fuel use) temperature and quantity to static mixer(s) circuit inlet.

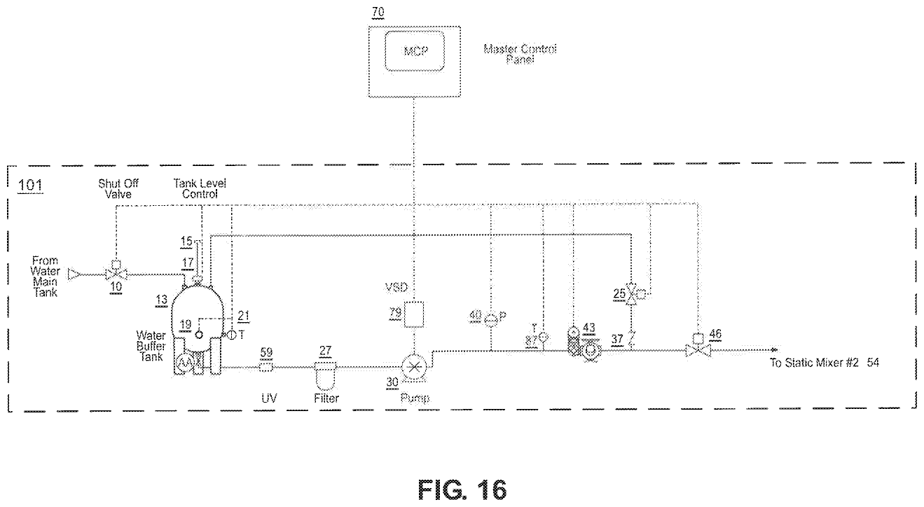

FIG. 16 depicts a detailed schematic view of a water circuit of said exemplary biofuel production assembly of the present invention depicted in FIG. 13. Water (purified preferred) is provided to said water circuit 101 including necessary valves, buffer reservoir tank, heater, ultraviolet light purifier, micro filter, pump with variable frequency drive and controller, temperature and pressure sensors, and precise metering and dosing equipment to supply specified water temperature and quantity to static mixer(s) circuit inlet.

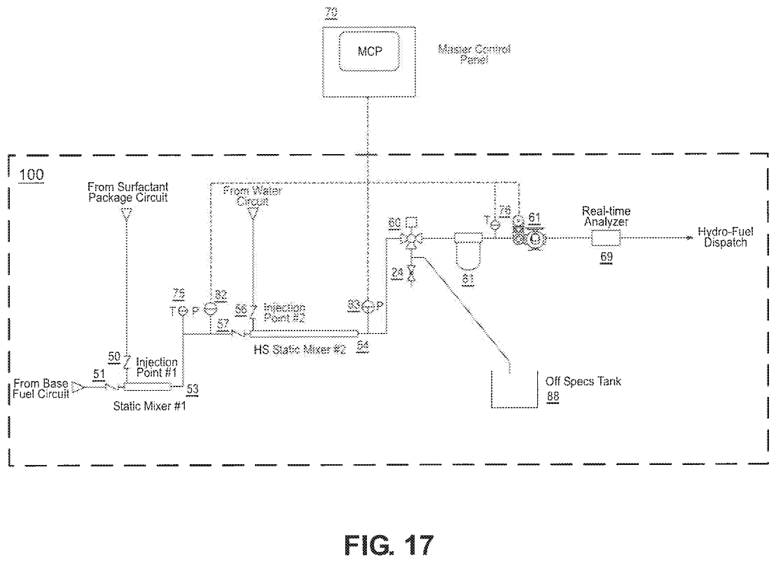

FIG. 17 depicts a detailed schematic view of a static mixing circuit of said exemplary biofuel production assembly of the present invention depicted in FIG. 13. As depicted in FIG. 17, at least two stages (or even subsequent stages, if desired) of dosing and static mixing circuit 100 are connected and fed from the other fluid circuits 101 through 103.

It is to be observed that additional additives may be added to the system and dosed in the blending process by additional inlets and dosing systems, not limited to cetane improver, pour point depressants, biocides, nano particle powders or gases such as hydrogen.

Each subsystem can comprise, but is not limited to, an individual pump, multiple solenoid and motorized valves, temperature and pressure sensors, and filters for each corresponding fluid. The emulsification process requires low energy for hydro-fuel microemulsion to assemble while fluids traveling through first stage static mixer and second stage static mixer. It is to be observed that only the second stage static mixer and dosing are necessary when a premix fuel solution is utilized, where only the water is dosed to produce the hydro-fuel microemulsion.

Said static mixers provide the turbulence required for blending and emulsifying fluids in order to produce the desired hydro-fuel microemulsion. The in-line smart blending system of the present invention can include, but is not limited to three inlets and one outlet, where the inlets are identified and not limited to base fuel (or premix fuel solution), a surfactant package and water, and an outlet for said hydro-fuel microemulsion.

The independent surfactants that make the surfactant package can also be independently dosed into the smart blending process, including other additives, where multiple dose inputs take place in the smart blending system. The In-line smart blending system can be controlled and powered by electrical power (alternating current or direct current) or other power source such as but not limited to renewables and can include an alarm and shut-off system for safety.

In a preferred embodiment, said in-line smart blending system is structurally supported through a metal frame composed of structural tubes or members The structural description is not to be taken in a limiting sense but made merely for the purpose of describing the necessity for structural design and integration into the process of the invention. The smart blending system structure can be integrated within a modular container or within the structure of a vessel deck, tractor trailer frame, a vehicle, or equipment such as a tractor or the like. The structural frame and apparatus/device support is not specific, and is designed and fabricated to suit the intended use environment, space/weight constraints, with various degrees of integration within any existing suitable structure and arranged in such manner as to facilitate the blending of multiple fluids.

Referring to FIGS. 13 through 17, base fuel supply circuit 103, surfactant supply circuit 102, water supply circuit 101 and static mixer circuit with hydro-fuel dispatch supply lines 100 are depicted. Metered base fuel supply (or premix fuel) flows from the base fuel circuit in a volumetric or mass monitored and controlled into the stop valve entry 51 of first stage static mixer 53. Metered surfactant package flows from the surfactant package circuit 102 in a volumetric or mass monitored and controlled into the stop valve entry 50 of the first stage static mixer 53. Said surfactant package is normally metered from the surfactant package circuit 102, when the base fuel supply is not a premix fuel source; otherwise circuit 102 can be disengaged.

The base fuel circuit 103 supplies base fuel (or premix fuel) at fuel filter inlet 29 with a fuel flow valve 12 controlled by the PLC/HMI Master Control Panel 70. When in the “on” position, base fuel flow is pressurized by at least one fuel supply pump 32 with is variable frequency drive 33 modulating the pump speed and pressure based on feedback loop connection between pressure sensor 42 and the master control panel 70 algorithm. In a preferred embodiment, base fuel supply is in an operating temperature range from about 1 C to about 45 C, or from about 10 C to about 60 C, or from about 30 C to about 100 C, which is controlled by heater control panel 71. Feed temperature of said base fuel pre-heater is nominally at ambient temperature conditions and elevated to within the prescribed operating temperature range by the in-line immersion heater 49 with a temperature sensor 89 and feedback connection to said control panel 71, master control panel 70 and algorithm.

The precise quantity or mass of base fuel or premix fuel solution is metered and dosed by the base fuel mass flow meter valve 45 which receives modulating control signals from said master control panel 70 and algorithm. When integrated with the valve, said mass flow meter can provide precise control over fluid flow in addition to measurement. The metered fuel flow passes through the electrical or pneumatic shut-off valve 48 to first stage static mixer 53 stop valve inlet 51, or in the event the shut-off valve is closed, said base fuel enters the recirculation line at non return valve (one-way check valve) 39 and control valve 55 to flow back to the base fuel supply source/tanks.

Moving through the surfactant supply circuit 102, surfactant is supplied from its supply source/tank prior to entry through the electrical or pneumatic shut-off valve 11 which is modulated by the master control panel 70 and algorithms. Surfactant then enters the optional surfactant reservoir tank 14 which operates as a buffer of surfactant that feeds the surfactant into the supply lines at valve (BB), ensuring air is not drawn into the system. The level of surfactant in said buffer tank is monitored by instrument 16 and temperature is maintained within a preferred range from about 1 degree C to about 45 degrees C, or from about 10 degrees C to about 60 degrees C, or from about 30 degrees C to about 100 degrees C, by element heater 20 and temperature sensor 22. Level sensor 16 and temperature sensor 22 feedback to the master control panel 70 and algorithms.

Surfactant passes through at least one low porosity filter 28 and such flow to the feed pump 31 is permitted and regulated by the variable frequency drive 80 and pressure is monitored by pressure sensor 41. Temperature is also monitored 88 within the prescribed operating range and fluid can be diverted back to the optional reservoir tank 14 by the closing of the electrical or pneumatic shut-off valve 47 and opening of valve 26. The precise quantity of surfactant is metered and dosed by the surfactant mass flow meter valve 44 which receives modulating control signals from said master control panel 70 and algorithm. When integrated with the valve, the Coriolis mass flow meter can provide precise control over fluid flow in addition to measurement. The metered surfactant flow passes through the electrical or pneumatic shut-off valve 47 to the first stage static mixer 53 stop valve inlet 50, or in the event the shut-off valve 47 is closed said surfactant enters the recirculation line at one-way check vale 38 and control valve 26 to flow back to the surfactant buffer reservoir tank 14.

The precise quantity of base fuel and surfactant are blended and homogeneously intermixed through at least one first stage static mixer 53. Said first stage static mixer 53 is sized to desired diameter, length, and internal geometry, accordingly, to provide sufficient blending time to create a complete homogenous blend of base fuel and surfactant. Said at least one first stage static mixer 53 can take the form of a helical, orifice plate, internal turbulator, or the like design. Such design can be arranged in a straight, coil, serpentine, or other arrangement within the In-line smart blending system 99 apparatus to provide sufficient blend time to produce a homogenous base fuel/surfactant blend. Illustrative examples of said at least one static mixer are depicted in FIGS. 6 and 7.

In the scenario where a premix of base fuel and surfactant comprises the base fuel supplied to the In-line smart blending system 99, said surfactant is already premixed before entering said in-line smart blending system 99 apparatus and therefore the dosing and metering of surfactant from circuit 102 to said at least one first stage static mixer 53 is disengaged and the mixing operation of said at least one first stage static mixer 53 is redundant. The master control panel 70 and internal instrumentation and control algorithms are programed to accommodate either the base fuel supply scenario or the premix fuel supply scenario, depending on particular operating parameters.

Purification of raw water supplied to water circuit 101 is performed either prior to or integrated within the in-line smart blending system (AA) to remove impurities, such as salts and metal elements from said water supply. The quality of the feedwater used in the assembly of hydro-fuel microemulsion process may comprise any type of water, for example, but not limited to sea water, river water, potable water, city water, well water or the like, but preferably deionized water, preferably having a resistivity ranging from about 1 to about 18 Megaohm, or from about 1 to about 10 Megaohm. Regardless of the source of water and method of purification (which can be, for example, desalination, ultrafiltration, nanofiltration and/or reverse osmosis, distillation, deionization, or other method) it is preferred for the water entering the water circuit 101 is of adequate purity for optimum hydro-fuel microemulsion production assembly.

Moving through said purified water supply circuit 101, the water is sourced from its supply tank and first passes through an electrical or pneumatic shut-off valve 10, which is controlled by the master control panel 70 and algorithms. Said water then enters reservoir water tank 13, serving as a buffer to regulate the volume or mass of water feeding into the water supply lines at valve 98, and ensuring air is not drawn into the system. Water level in said buffer tank is monitored by instrument 15, and its temperature is programmed to be at a preferred range from about 1 degree C to about 45 degrees C, or from about 10 degrees C to about 60 degrees C, or from about 30 degrees C to about 99 degrees C by heater element 19 and a temperature sensor 21. Both the level sensor 15 and temperature sensor 21 provide feedback to the master control panel 70 and algorithms.

Said water then passes through an ultraviolet light purifier 59 and a low-porosity bacteria filter 27 to filter any biological organisms and enhance water quality. After purification, the water flows through to the water supply pump 30. The pump speed is regulated by a variable frequency drive 79 and its pressure is monitored by a pressure sensor 40. The temperature is also monitored 87 to ensure it remains above a predetermined prescribed temperature.

If necessary, the water can be diverted back to the reservoir tank 13 by closing automate (electrical or pneumatic powered) shut-off valve 46 and passing through one-way check valve 37 when control valve 25 is open. The precise quantity of water is metered and dosed by mass flow meter valve 43, which receives control signals from the master control panel 70. When integrated with the valve, said mass flow meter can provide precise control over fluid flow in addition to measurement. Finally, the metered water flow passes through the electrical or pneumatic shut-off valve 46 to at least one second stage static mixer 54 stop valve inlet 56.

Other additive fuel circuits, such as cetane improver, pour point depressants, biocide, nano-particles or gasses (hydrogen, oxygen or the like) can be integrated into the In-line smart blending system 99 in a similar manner, whereby the addition of such fluid or solid or gas additive is immediately prior to subsequent stative mixing devices of sufficiently length, diameter, and internal design, to enable a complete thermodynamically stable hydro-fuel microemulsion at its outlet. The surfactant package can also be dosed in the in-line smart blending system by their individually based surfactant(s) and chemicals, individually dosed. Whether surfactant is as a package, or the package is broken down into individual surfactants and chemicals to be dosed independently, the assembly of the hydro-fuel microemulsion can be achieved in either scenario.

The static mixer circuit 100 comprises at least one initial static mixer which blends the base fuel with the surfactant to a homogeneous solution, followed by temperature sensor 75 which provides feedback to the master control system 70 and provides input via the algorithms to adjust up, down or stabilize the feed temperatures provided by the individual circuit heaters 49, 20 and 19.

The surfactant package comprises at least one surfactant that as a package are capable of forming microemulsions that require low energy delivered by the static mixing apparatuses 53 and 54. Formation of microemulsion can rely upon chemical energy provided by said surfactant package formulated via HLD method, administered through the surfactant circuit 102 to the static mixer circuit 100. The HLD formulated surfactant combined with the static mixing process creates a thermodynamically stable hydro-fuel microemulsion.

Said first and second stage static mixers 53 and 54 are instrumental in the production of a quality microemulsion. However, said surfactant also plays an important role in said microemulsion production based upon high chemical energy self-assembly characteristics presented by the HLD formulated surfactant package during the microemulsion formation process. Proper design and selection of static mixers ensure optimal performance, high operational efficiency and long-term useful life. As previously noted, static mixers can take various dimensions, forms, and designs.

As the mixed fluid exits second stage static mixer 54, it becomes a completed hydro-fuel microemulsion ready to be utilized in the application. This hydro-fuel then passes through a final fuel filter 81, where both its temperature 76 and pressure 83 are measured and communicated back to master control panel 70. A final hydro-fuel flow meter valve 61 regulates the hydro-fuel microemulsion flow through a real-time in-line quality analyzer 69, which is also connected to said master control panel 70 for continuous monitoring to ensure quality of the hydro-fuel microemulsion quality real-time. In-line monitoring can include, but is not limited to, measurement of viscosity, density, cetane number, water content, flash point, or other desired variables.

Hydro-fuel meeting predetermined quality specifications is then supplied to storage tanks, engine fuel systems, or other transportation mediums such as fuel barges for use in the application. Any hydro-fuel that does not satisfy said predetermined quality specifications is automatically diverted to a storage container 88 via valve 60 based on feedback from the real-time quality analyzer 69. The real-time quality analyzer 69 monitors various quality measurements of the hydro-fuel microemulsion in real time including and not limited to viscosity, density, cetane number, cetane index, water content, or the like.

The materials used to construct the subcomponents, pipes, mixers, pumps, valves, and other parts of the In-Line smart blending system 99 are not limited to black iron, carbon steel, stainless steel, aluminum, PVC, or other. PVC material can also be used for pipes and static mixing devices. However, it is crucial to thoroughly consider the operational environment and use case to prevent unnecessary breakage and wear of components. Stainless steel may be used in marine environments.

Although the in-line fuel blending system of the present invention is described herein according to a dosing sequence of base fuel, then surfactant(s) (as a package or individually dosed surfactants or other chemicals) then water, said dosing sequence can be altered without departing from the scope of the present invention.

Said In-line smart blending system 99 can be beneficially controlled by a master control panel 70 and its algorithms and the base fuel in-line heater control panel 71. The master control panel receives continuous signal feedback from various temperature, pressure, and flow rate sensors of the smart blending system 99 including its sub-circuits 100, 101, 102 and 103. Each circuit is equipped with various temperature and pressure sensors, as well as electronically or pneumatically actuated valves, pumps, and dosing meters.

In a preferred embodiment, the present invention comprises an In-line smart blending system of hydro-fuels. The In-line smart blending system can be integrated into new or existing infrastructure or equipment. Further, the In-line smart blending system technology of the present invention can be used in connection with 1) stationary on-site blending, 2) mobile/portable on-site blending, and 3) on-board vehicle/ship/equipment blending, whether a base fuel is utilized, or a premix of base fuel and surfactant made in advanced is utilized for the assembly of the hydro-fuel microemulsion using the in-line smart blending system.

The present invention comprises an in-line multifuel blending apparatus configured to produce water in fuel microemulsions. Said blending apparatus requires low mechanical energy by utilizing static mixing devices combined with a high chemical energy interaction with formulated hydrophilic-lipophilic difference (HLD) surfactant(s), purified water, and base fuel. Said apparatus can be mounted on a skid, container, on board vessel, or on other equipment.

A set volume or mass of surfactant having a hydrophilic-lipophilic difference (HLD) value in the range of −3 to +3 can be added to a set volume or mass of base fuel. Said base fuel can include, without limitation, diesel fuel, kerosene, jet fuel, marine gas/fuel oils, light and heavy fuel oils, renewable diesel, bio diesels, synthetic, e-fuels, or other fuels with similar characteristics to fuel oils.

In one embodiment, said base fuel is blended together with surfactant(s) within a first stage static mixing device in order to form a base fuel-surfactant premix. Thereafter, water can be blended with said premixed base fuel-surfactant solution in a second stage static mixing device inline, on skid. Such blending can occur in an in-line single pass mixing process and does not require any intermediate aging or circulation tanks.

A surfactant circuit comprises reservoir tank heaters or in-line immersive heater(s), feed pump(s), shutoff valve(s), temperature and pressure sensor(s), and metering and dosing devices, all configured to be monitored and controlled by a master control panel with integral control algorithms. Said surfactant circuit dosing devices may be selectively disengaged when a premix of base fuel and surfactant(s) is utilized.

A purified water circuit comprises reservoir tank heater(s) or inline immersive heater(s), feed pump(s), shutoff valve(s), temperature and pressor sensor(s), and metering and dosing device(s) all configured to be monitored and controlled by a control panel with control algorithms.

Base fuel or premixed base fuel-surfactant solution can beneficially be in a temperature range from about 1 degree C to about 45 degree C, or from about 10 degree C to about 60 degree C, or from about 30 degree C to about 100 degree C; said ranges are preferred for effective blending. Said temperatures can be ensured through use of: 1) in-line immersion heater(s) for base diesel fuel or premixed base fuel-surfactant solution, 2) buffer reservoir tank heater(s) or in-line immersive heater(s) for the surfactant circuit. Water temperature range from about 1 degree C to about 45 degree C, or from about 10 degree C to about 60 degree C, or from about 30 degree C to about 99 degree C is preferred for effective blending and such temperature can be ensured through buffer reservoir tank heater(s) or inline immersive heater(s) for a water circuit.

Additional additives, including but not limited to dyes, cetane improvers, pour point depressants, biocides, gases (including, but not limited to hydrogen or oxygen), or nano particle powders can be included in the hydro-fuel through additional mixing stages using static mixers appropriate for the medium being added.

In a preferred embodiment, a produced hydro-fuel microemulsion comprises:

| Actual Blending Ratios | Vol. % (broad range) | Vol. % (narrow range) |
|---|---|---|
| Base oil (fuel) | 50 to 90 | 75 to 85 |
| Water | 0.5 to 30 | 10 to 20 |
| Surfactant Package | 0.5 to 15 | 2 to 8 |

Dosage of predetermined blend ratios can be determined by volumetric and/or mass measurement in order to control process accuracy. Said produced hydro-fuel comprises a homogeneous and clear hydro-fuel microemulsion, even when additional additives are employed. The finished hydro-fuel product is thermodynamically stable and ready for use in applications including, but not limited to, diesel engine, turbine engine and boiler combustion.

In a preferred embodiment, a premixed base fuel-surfactant solution comprises:

| Actual Blending Ratios | Vol. % (broad range) | Vol. % (narrow range) |
|---|---|---|
| Base oil (fuel) | 50 to 90 | 75 to 85 |
| Water | 0 | 0 |
| Surfactant Package | 0.5 to 15 | 2 to 8 |

Dosage of predetermined blend ratios can be determined by volumetric and/or mass measurement to control process accuracy.

Blending of water with said premixed base fuel-surfactant solution to produce a hydro-fuel microemulsion, comprises:

| Actual Blending Ratios | Vol. % (broad range) | Vol. % (narrow range) |
|---|---|---|
| Base Fuel + Surfactant | 50 to 90 | 75 to 85 |
| Premix | | |
| Water | 0.5 to 30 | 10 to 20 |
| Surfactant Package | 0 | 0 |

Wherein dosage of predetermined blend ratios can be determined by volumetric and/or mass measurement to control process accuracy.

In accordance with the present invention, high energy consuming mixing devices (including, but not limited to shear mixers, high pressure emulsifiers, hydrodynamic cavitation or ultrasonic equipment) are not required. HLD formulated surfactant(s) enable the formation of a thermodynamically stable microemulsion blend of water, oil, and surfactant (and/or other additives). Said HLD formulated surfactant relies on high chemical energy interaction of said fluids to spontaneously form microemulsion effectively during blending in low energy static mixing devices.

The following is an illustrative example composition and properties of hydro-fuel microemulsions:

| Microemulsion | Vol. % (broad range) | Vol. % (narrow range) |
|---|---|---|
| Base oil (fuel) | 50 to 90 | 75 to 85 |
| Water | 0.5 to 30 | 10 to 20 |
| Surfactant | 0.5 to 15 | 0.5 to 8 |
| EACN | 7 to 15 | 9 to 13 |
| CC number | −10 to 10 | 1.8 to 2.1 |

| | |
|---|---|
| Additives | As needed for HLD −3 to +3 |
| Biocide | As needed for HLD −3 to +3 |
| Salinity | As needed for HLD −3 to +3 |

A first stage static mixing process incorporates precise metering and dosing devices that are controlled by a master control panel and programmed computer algorithm(s) to ensure precise dosing volumes or masses of base fuel and surfactant within preferred ranges.

A second stage static mixing process incorporates precise metering and dosing devices that are controlled by a master control panel and programmed computer algorithms to ensure precise dosing volumes or masses of water within preferred ranges.

The metering and dosing devices of the present invention can be beneficially controlled and metered by sensor feedback (including, without limitation, measured properties) communicated to a master control panel. Data from multiple flow measurement and metering sensor instruments within the apparatus communicate with said master control panel HMI/PLC system in order to control operations of valves and other components to precisely dose ingredients of the hydro-fuel microemulsion. Multiple fluid heating devices adjust fluid temperatures to prescribed values via the master control panel HMI/PLC system and heater control panel.

Water can be treated with ultra-violet light purification system and/or bacteria filter that further purifies water and removes organic contamination in-line, including immediately prior to dosing with the base fuel-surfactant solution.

Low energy static mixing devices include a series of internal baffles, or the like, to enhance mixing efficiency with a cross current flow path to effectively mix and blend fluids. In a preferred embodiment, said static mixing devices can comprise multiple internal stages to maximize mixing in as short a path length as possible. Said static mixing devices can be arranged in any number of configurations including a single linear pathway, or multiple serpentine pathways, or even cylindrically coiled pathway.

Sensors for monitoring various measured qualities throughout the blending system; such monitoring ensures real time quality measurement of interstage fluids and hydro-fuel microemulsion production. Such quality monitoring includes the measurement of and is not limited to density, viscosity, certain number, cetane index, aromatics, cloud point, pour point, carbon factor, water content. Measured data is communicated to a master control panel. Preset computer programming and algorithms provide for corrective action and/or alarm notification in the event that sensed measurements fall outside of predetermined range(s). Said master control panel (i.e. control system) comprises a programmable logic controller (PLC) for automated regulation of fluid inputs flows, temperatures, pressures, valve operation, system alarms, fluid circuit disengagement, and system on and off. Said control panel further comprises HMI and telemetry systems to relay data and permit operational control functions to remote location(s).

The in-line smart blending system production of hydro-fuels can be stationary or portable to serve applicable industry or other requirements. As such, hydro-fuel can be produced at a desired location and then transported to another location for use or on-site storage ready for the application. Stationary installations of the smart blending system and/or the premix fuel solution can be adapted in various locations for production, not limited to fuel hubs, fuel terminals, refineries, different operation sites, on-board vessel/ship, where hydro-fuel production and/or usage is desired in the application.

The in-line smart blending system of the present invention can also be portable in cases where hydro-fuel production is required at different sites and/or where fuel transportation is not convenient or cost-effective. Such portable In-line smart blending production system(s) can be transported to a desired location and used on-site so that hydro-fuel can be produced and used in operations or otherwise stored at said location for later use. The In-line smart blending system of the present invention can be trailer or truck-mounted and be used as a mobile unit to be brought to job sites for on-site hydro-fuel production.

The in-line smart blending system of the present invention can me composed of a single static mixer when a pre-mix solution is provided as the feed base fuel, where only water dosing is required to complete the production of hydro-fuel microemulsion. In this instance, the precise and controlled dosing and metering of water is introduced to the premixed base fuel prior to entry of the static mixer in the smart blending system.

An on-board hydro-fuel blending system for marine applications may provide benefits for transportation vessels that provide refueling to other vessels at sea. In first application, a refueling vessel may contain base fuel (as they normally do) and desired volume(s) of surfactant(s) in storage tanks or containers. On-board water purification system can supply clean and purified water as a source to feed the smart blending system to produce the hydro-fuel microemulsion. Hydro-fuel may be produced in real-time while refueling another vessel at sea, on a single pass. Further, it is to be understood that one or more components of the in-line blending process can be located on multiple vessels that are operationally networked together. Alternatively, a marine refueling vessel may include premixed base fuel in onboard storage container(s); water can be added using the smart blending system in real-time to produce hydro-fuel microemulsion in order to refuel other vessel(s) in a marine environment.

The subject matter of the present invention is described with specificity herein to meet statutory requirements. However, the description itself is not intended to necessarily limit the scope of claims. Rather, the claimed subject matter might be embodied in other ways to include different steps or combinations of steps similar to the ones described in this document, in conjunction with other present or future technologies. Although the terms “step” and/or “block” or “module” etc. might be used herein to connote different components of methods or systems employed, the terms should not be interpreted as implying any particular order among or between various steps herein disclosed unless and except when the order of individual steps is explicitly described.

Furthermore, the described features, structures, or characteristics may be combined in any suitable manner in one or more embodiments. In the following description, numerous specific details are provided. One skilled in the relevant art will recognize, however, that the membrane-based extraction method may be practiced without one or more of the specific details, or with other methods, components, materials, and so forth. In other instances, well-known structures, materials, or operations are not shown or described in detail to avoid obscuring aspects of the invention.

1. An in-line blending apparatus for producing thermodynamically stable microemulsion hydro-fuel comprising:
a) a first fluid conduit having an inlet configured to receive at least one base fuel, wherein said base fuel comprises at least one of the following: diesel, gasoline, heavy fuel oil, marine fuels, kerosene, jet fuel, biodiesel, renewable diesel or synthetic e-fuel;
b) an inlet configured to receive at least one surfactant having a hydrophilic-lipophilic difference in the range of −3 to +3 into said fluid conduit;
c) a pump configured to pump said at least one base fluid and said at least one surfactant through a first static mixer;
d) a second conduit configured to receive effluent from said first static mixer;
e) an inlet configured to receive purified mix water into said second conduit;
f) a second stationary mixer that is configured to mix said mix water with said fuel and surfactant blend to produce said thermodynamically stable microemulsion hydro-fuel.

2. The in-line blending apparatus of claim 1, wherein at least one of said first static mixer and said second stationary mixer comprises a conduit body having a fluid inlet, a fluid outlet, and a plurality of internal mixing elements disposed in spaced arrangement within said conduit body and configured to simultaneously produce fluid flow division and radial mixing of fluids passing therethrough, said internal mixing elements comprising a geometry selected from the group consisting of helical elements, orifice plates, internal baffles and internal turbulators, and wherein said conduit body is arranged in a linear, coiled, cylindrical or serpentine configuration adapted to increase fluid retention time and exposure of said fluids to said internal mixing elements.

3. The in-line blending apparatus of claim 1, further comprising at least one in-line immersion heater disposed upstream of said first static mixer and at least one temperature sensor in feedback communication with a heater control panel, said in-line immersion heater being configured to elevate the temperature of said base fuel from ambient conditions to a temperature within a range of from about 1 degree C to about 100 degrees C prior to entry of said base fuel into said first static mixer.

4. The in-line blending apparatus of claim 1, further comprising a water circuit in fluid communication with said inlet configured to receive purified mix water, said water circuit comprising a buffer reservoir tank, a heater element, a level sensor, a temperature sensor, an ultraviolet light purifier, a bacteria filter, a water supply pump, a variable frequency drive regulating the speed of said water supply pump, and a pressure sensor.

5. The in-line blending apparatus of claim 1, further comprising a surfactant circuit in fluid communication with said inlet configured to receive at least one surfactant, said surfactant circuit comprising a buffer reservoir tank, a level sensor, a heater element, a temperature sensor, at least one low porosity filter, a feed pump, a variable frequency drive regulating the speed of said feed pump, and a pressure sensor, wherein said surfactant circuit is configured to be selectively disengaged when said base fuel received at said first fluid conduit comprises a premixed base fuel-surfactant solution.

6. The in-line blending apparatus of claim 1, further comprising a plurality of mass flow meter valves, wherein a first said mass flow meter valve is configured to meter and dose said base fuel, a second said mass flow meter valve is configured to meter and dose said at least one surfactant, and a third said mass flow meter valve is configured to meter and dose said purified mix water, each said mass flow meter valve being responsive to modulating control signals so as to provide control over fluid flow in addition to measurement thereof.

7. The in-line blending apparatus of claim 1, further comprising a master control panel comprising a programmable logic controller and a human machine interface in feedback communication with a plurality of temperature sensors, pressure sensors, level sensors and flow rate sensors of said apparatus and configured to regulate fluid input flows, temperatures, pressures, valve operation, fluid circuit disengagement, system alarms, and system on and off states, a telemetry system configured to relay data and permit operational control functions from a remote location, and at least one recirculation line comprising a one-way check valve and a control valve configured to return fluid to an upstream supply source when an associated shut-off valve disposed upstream of said first static mixer is in a closed position.

8. The in-line blending apparatus of claim 1, further comprising a quality control subsystem comprising a plurality of in-line analyzers, wherein each said in-line analyzer is dedicated to a single measured property and comprises a discrete analyzer body mechanically integrated into a wall of a respective fluid conduit of said apparatus so as to dispose a sensing element of said in-line analyzer in direct contact with fluid flowing therethrough, each said in-line analyzer being electrically connected to a master control panel of said apparatus and in bidirectional data communication with a programmable logic controller executing stored control algorithms, whereby a measured value from each said in-line analyzer is acquired in real time and utilized by said programmable logic controller to regulate operation of said apparatus.

9. The in-line blending apparatus of claim 8, wherein said plurality of in-line analyzers comprises a dedicated in-line conductivity analyzer and a separate dedicated in-line resistivity analyzer, each disposed within a water circuit of said apparatus downstream of a water purification device and upstream of said inlet configured to receive purified mix water, said separate dedicated in-line resistivity analyzer being configured to measure a resistivity of said purified mix water within a range of from about 1 to about 18 Megaohm, and wherein said programmable logic controller is configured, upon a conductivity value or a resistivity value falling outside a stored predetermined water purity specification, to execute at least one of the following: inhibit metering of said purified mix water, divert said purified mix water to a recirculation line, and generate an alarm notification at a human machine interface of said master control panel.

10. The in-line blending apparatus of claim 8, wherein said plurality of in-line analyzers comprises a dedicated in-line viscosity analyzer, a separate dedicated in-line density analyzer, and a separate dedicated in-line cetane number analyzer, each disposed within a base fuel circuit of said apparatus upstream of said first static mixer and each configured to measure a corresponding property of said at least one base fuel prior to blending thereof with said at least one surfactant, and wherein said programmable logic controller is configured to modulate a temperature setpoint of a heater disposed within said base fuel circuit in response to a viscosity value measured by said dedicated in-line viscosity analyzer so as to maintain said at least one base fuel within a predetermined viscosity range at an inlet of said first static mixer.

11. The in-line blending apparatus of claim 8, wherein said plurality of in-line analyzers comprises a dedicated in-line density analyzer and a separate dedicated in-line viscosity analyzer, each disposed within a surfactant circuit of said apparatus downstream of a filter and upstream of said first static mixer and each configured to measure a corresponding property of said at least one surfactant prior to dosing thereof into said first fluid conduit, and wherein said programmable logic controller is configured to modulate a metering and dosing device of said surfactant circuit in response to a density value measured by said dedicated in-line density analyzer so as to maintain a predetermined ratio of said at least one surfactant to said at least one base fuel on a mass basis.

12. The in-line blending apparatus of claim 8, wherein said plurality of in-line analyzers comprises a dedicated in-line density analyzer, a separate dedicated in-line viscosity analyzer, a separate dedicated in-line cetane number analyzer, a separate dedicated in-line light transmission analyzer, and a separate dedicated in-line water content analyzer, each disposed downstream of said second stationary mixer and each configured to measure a corresponding property of said thermodynamically stable microemulsion hydro-fuel in real time, and further comprising a diversion valve disposed downstream thereof and configured to be actuated by said programmable logic controller so as to divert said microemulsion hydro-fuel to a storage container upon a measured value from any one of said dedicated in-line analyzers falling outside a predetermined quality specification.

13. The in-line blending apparatus of claim 12, wherein said separate dedicated in-line light transmission analyzer comprises a light source and a photodetector disposed across a flow path of said thermodynamically stable microemulsion hydro-fuel, and wherein said programmable logic controller is configured to compare a light transmission value measured thereby against a stored threshold value corresponding to a translucent to clear appearance, whereby a measured light transmission value at or above said stored threshold value indicates formation of said thermodynamically stable microemulsion hydro-fuel and a measured light transmission value below said stored threshold value indicates an opaque emulsion.

14. The in-line blending apparatus of claim 8, further comprising at least one dedicated in-line analyzer disposed intermediate said first static mixer and said second stationary mixer and configured to measure at least one property of an interstage base fuel-surfactant blend prior to introduction of said purified mix water, whereby homogeneity of said interstage base fuel-surfactant blend is verified in real time by said programmable logic controller.

15. The in-line blending apparatus of claim 8, wherein said programmable logic controller stores a predetermined setpoint range corresponding to each said in-line analyzer and is configured, upon a measured value falling outside a corresponding said predetermined setpoint range, to execute at least one corrective action selected from the group consisting of adjusting a metering and dosing device, adjusting a heater setpoint, adjusting a variable frequency drive of a pump, actuating a diversion valve, and generating an alarm notification, and is further configured to transmit each said measured value and each said corrective action to a remote location by way of a telemetry system.

16. The in-line blending apparatus of claim 1, further comprising at least one additional inlet disposed immediately upstream of a subsequent static mixing device and configured to receive at least one additive selected from the group consisting of dyes, cetane improvers, pour point depressants, biocides, nano particle powders, hydrogen gas and oxygen gas, and wherein said apparatus is supported by a structural frame and is mounted upon at least one of a skid, a sea container, a trailer, a truck, a vehicle deck, a floating vessel, or mobile equipment, whereby said apparatus is transportable between a plurality of locations for on-site production of said microemulsion hydro-fuel.

17. The in-line blending apparatus of claim 1, wherein said apparatus is configured to produce said thermodynamically stable microemulsion hydro-fuel comprising from about 50 to about 90 volume percent base fuel, from about 0.5 to about 30 volume percent water, and from about 0.5 to about 15 volume percent surfactant, and preferably from about 75 to about 85 volume percent base fuel, from about 10 to about 20 volume percent water, and from about 2 to about 8 volume percent surfactant.

18. A method of producing a thermodynamically stable microemulsion hydro-fuel, said method comprising the steps of:
a) metering a quantity of base fuel into a first fluid conduit, wherein said base fuel comprises at least one of diesel, gasoline, heavy fuel oil, marine fuel, kerosene, jet fuel, biodiesel, renewable diesel or synthetic e-fuel;
b) metering a quantity of at least one surfactant having a hydrophilic-lipophilic difference (HLD) value in the range of −3 to +3 into said first fluid conduit;
c) passing said base fuel and said at least one surfactant through a first static mixer to form a substantially homogeneous base fuel-surfactant blend;
d) directing effluent from said first static mixer into a second conduit;
e) metering a quantity of purified water into said second conduit;
f) passing said base fuel-surfactant blend and said purified water through a second static mixer, whereby chemical energy of said at least one surfactant causes spontaneous self-assembly of said base fuel, said at least one surfactant and said purified water into a thermodynamically stable microemulsion hydro-fuel; and
g) discharging said thermodynamically stable microemulsion hydro-fuel from an outlet of said second static mixer;
wherein steps (a) through (g) are performed in a single pass through said first static mixer and said second static mixer without the use of any intermediate aging tank, interstage storage tank or circulation tank, and without the use of high shear mixers, ultrasonic emulsification equipment, high pressure emulsifiers, homogenizers or hydrodynamic cavitation devices.

19. The method of claim 18, further comprising the steps of:
a) measuring, by a dedicated in-line conductivity analyzer and by a separate dedicated in-line resistivity analyzer, a conductivity and a resistivity of said purified water prior to said metering of said purified water;
b) measuring, by a dedicated in-line viscosity analyzer, by a separate dedicated in-line density analyzer and by a separate dedicated in-line cetane number analyzer, a viscosity, a density and a cetane number of said base fuel prior to said metering of base fuel;
c) measuring, by a dedicated in-line density analyzer and by a separate dedicated in-line viscosity analyzer, a density and a viscosity of said at least one surfactant prior to said metering of step surfactant;
d) measuring, by a dedicated in-line density analyzer, by a separate dedicated in-line viscosity analyzer, by a separate dedicated in-line cetane number analyzer, by a separate dedicated in-line light transmission analyzer and by a separate dedicated in-line water content analyzer, a density, a viscosity, a cetane number, a light transmission and a water content of said thermodynamically stable microemulsion hydro-fuel following said passing of said base fuel-surfactant blend and said purified water through a second static mixer;
e) communicating each measured value to a programmable logic controller and adjusting at least one of the metering steps in response thereto; and
f) diverting said thermodynamically stable microemulsion hydro-fuel to a storage container when a measured value obtained from any one of said dedicated in-line analyzers falls outside a predetermined quality specification range.

20. An in-line blending apparatus for producing thermodynamically stable microemulsion hydro-fuel from a premixed base fuel-surfactant solution, said apparatus comprising:
a) a conduit having an inlet configured to receive a premixed base fuel-surfactant solution comprising a base fuel and at least one surfactant having a hydrophilic-lipophilic difference in the range of −3 to +3;
b) a water circuit comprising a water purification device, a dedicated in-line conductivity analyzer, a separate dedicated in-line resistivity analyzer, and a metering and dosing device configured to introduce a measured quantity of purified water into said conduit;
c) a single static mixer disposed downstream of said inlet and configured to blend said purified water with said premixed base fuel-surfactant solution to produce said thermodynamically stable microemulsion hydro-fuel;
d) at least one dedicated in-line analyzer disposed downstream of said single static mixer and configured to measure a property of said thermodynamically stable microemulsion hydro-fuel; and
e) a control system comprising a programmable logic controller electrically connected to and in bidirectional data communication with each said dedicated in-line analyzer and configured to regulate said metering and dosing device in response thereto;
wherein said apparatus is configured to produce said thermodynamically stable microemulsion hydro-fuel in a single pass without dosing of additional surfactant.
